(19) United States
(12) Patent Application Publication
(10) Pub. No.: US 2014/0236610 A1
(43) Pub. Date: Aug. 21, 2014

(54) METHOD FOR REDUCING ILLNESS IN CARE FACILITIES

(71) Applicant: Kimberly-Clark Worldwide, Inc., Neenah, WI (US)

(72) Inventors: Michael A. Daley, Appleton, WI (US); David W. Koenig, Menasha, WI (US); Stephanie M. Martin, Johns Creek, GA (US); Kevin P. McGrath, Alpharetta, GA (US); Theodore T. Tower, Appleton, WI (US); Bruce S. Williamson, Alpharetta, GA (US); Clarice M. Theisen, Alpharetta, GA (US); Jennifer M. Kaminski, Roswell, GA (US); Christof J. Baer, Tonbridge (GB); Laura M. McLaughlin, Parkland, FL (US); Bryan John Semkuley, Roswell, GA (US)

(73) Assignee: Kimberly-Clark Worldwide, Inc., Neenah, WI (US)

(21) Appl. No.: 14/155,688

(22) Filed: Jan. 15, 2014

Related U.S. Application Data
(60) Provisional application No. 61/758,905, filed on Jan. 31, 2013.
(60) Provisional application No. 61/883,537, filed on Sep. 27, 2013.

(51) Int. Cl. G06Q 50/22; G06Q 10/06

(52) U.S. Cl. CPC G06Q 50/22; G06Q 10/063
USPC 705/2

(57) ABSTRACT

There is provided a method for promoting hygiene and reducing illness in a resident care location. The method collects data from a resident care location by testing common areas and personal areas within the resident care location, uses data specific to each resident, uses this data to develop tasks for the caregiver(s), measures and scores compliance with the tasks, and provides feedback for improved compliance with the tasks.

This application claims priority from U.S. provisional patent applications 61/758,905 filed on Jan. 31, 2013 and from 61/883,537 filed Sep. 27, 2013, respectively.

### BACKGROUND

This disclosure is concerned with the need for reducing the incidence of illness among residents of care facilities, particularly senior citizens having potentially compromised immune systems, e.g. elderly residents.

Particular concern is directed to those residing in skilled nursing facilities, hospitals, urgent or emergency care, home professional services, assisted living facilities, apartments, or home care. In addition to the benefit of reducing preventable illnesses as a method of promoting hygiene and/or wellness, methods such as this are expected to decrease pain and suffering, reduce costs by proactively reducing preventable occurrences versus treatment of preventables, and result in increased engagement, satisfaction and good-will within the resident's sphere of interaction including and/or among the following groups: doctors, nurses, staff and administration, family members and other residents.

Despite improvements in hand hygiene, stricter compliance requirements, and efforts to optimize isolation practices, hospitals and other healthcare facilities are losing the war on nosocomial or Hospital Acquired Infections (HAIs). An HAI is an infection acquired in a hospital or other healthcare facility by a patient admitted for some reason other than that specific infection. HAIs may include infections appearing 48 hours or more after admission or within 30 days after discharge. They may also include infections due to transmission from colonized healthcare workers, or occupational exposure to infection among staff of the facility. The majority of HAIs are preventable, yet they are expensive in terms of human suffering as well as in the cost of their cure.

Many factors contribute to the increased incidence of HAIs among care facility patients. The immune system generally weakens with age, thus reducing the ability of care facility patients or residents to fight off infections. Medical and other staff move from patient to patient and see many patients a day, providing a way for pathogens to spread. Research indicates that hand hygiene practices remain generally poor and staff turnover can be high at, for example, assisted living and skilled nursing facilities.

While some attempts at improving compliance of hospital cleaning staff have been made, e.g. US patent publications 2012/0173274 and 2006/0277065, these are not comprehensive programs that involve the resident and the entire facility staff. Some other programs are only directed to hand hygiene and do not address other potential sources of contamination or the ways to mitigate those sources of contamination, such as contamination found on surfaces.

There is a need for system or method which will promote hygiene and cleanliness at institutional facilities that goes beyond the mere washing and sanitizing of hands of people within the organization. This system should address other areas of concern, such as surfaces, objects and other potential sources of contamination that may occur at resident care locations and also involve the staff in a comprehensive program.

### SUMMARY

Generally stated, the present disclosure provides a method that is a comprehensive and systematic approach to promote hygiene and reduce preventable illnesses in a resident care location. It achieves this goal by driving behavior change among those at the resident care location in a manner so as to improve hygiene in the resident care location and to potentially reduce the spread of illness within the resident care location

In one embodiment of the present disclosure, there is provided a method that promotes hygiene and reduces preventable illnesses in a resident care location. While the steps of the method need not be carried out using a computer, it is contemplated that such a system will be used because of the ease of computation, entering and outputting data and the centralized monitoring and storage of information that the computer affords. Input devices may be, for example, I-Pad or other tablet type devices.

The method can include the following steps:

a. Collect heath and sickness data among residents. The sickness data among residents may be captured through institutional reports, observations of the staff or input by the resident and/or family member.

b. Collect certain conditional data of the residents.

c. Provide tasks to staff and caregivers for management of the residents. Tasks are based on collected data and stored data. Examples of tasks include staff hand hygiene, resident personal care (e.g. oral care, perineal cleaning), environmental cleaning, monitoring such as adenosine triphosphate (ATP) sampling.

d. Track completion of the tasks.

e. Score compliance to the tasks and provide scoring.

f. If necessary, generate customized tasks in managing certain residents based on tracking, scoring, and data to reduce the transfer of pathogens within the facility.

g. Generate feedback, e.g. incentives, for care givers based on tracking, scoring, deviations from tasks, and data.

In a further embodiment of the present disclosure, the method may include using evaluation protocols at multiple resident care locations and compiling the collected data in a database. The data collected may include information regarding what was successful and what was not successful for a given resident care location. The use of “protocols” are intended as tasks; i.e., protocols are a series of tasks, e.g., do this first, then that next, then X, Y, Z a designated number of times a day.

In another aspect of the present disclosure, the method includes one or more means to motivate care givers within the resident care location to drive compliance with the tasks. Suitable employee or user motivational means may include posters, e-mails, videos, surveys, feedback/progress cards, contests, prizes for compliance and/or positive outcomes and combination thereof.

In a further embodiment of the present disclosure, the method will include specific products and methods of using the products to reduce contamination. Suitable products include but are not limited to hand sanitizer, skin and body cleansers, surface cleaners, surface sanitizers/disinfectants and/or facial tissues or combinations thereof. Additional products that may be used in the performance of the tasks include hand soaps, hand cleaners, disposable hand towels, computer keyboard and touch pad cleaning devices, air disinfecting products, including sprays or air filtration products or a combination thereof. Generally the surface cleaner, surface sanitizer or surface disinfectant may be in the form of a saturated wipe, a spray, foam, or a liquid. In a further particular embodiment, the surface sanitizer or surface disinfectant may provide surface sanitation or disinfection which lasts for more than 2 hours.

The method of the present disclosure, in a further embodiment, may also include providing assistance to the resident care location with implementing the plan of action for a period of time prior to reevaluating the resident care location. Exemplary assistance may include providing employee or user motivational means to engage people within the resident care location to drive compliance with the method.

### BRIEF DESCRIPTION OF THE DRAWINGS

FIGS. 1 through 8 are illustrations of a Probabilistic Graphical Model using hypothetical numbers for the probability of infection given a certain Germ, Product, and Behavior combination and producing a certain Health Metric.

FIG. 1 assumes that half the time the products were used, half the time behavior was good, and half the time germ loading was high, as well as the assumed conditional probability distribution of the Health Metric.

FIG. 2 assumes that all of the time the products were used, half the time behavior was good, and half the time germ loading was high, as well as the assumed conditional probability distribution of the Health Metric.

FIG. 3 assumes that all of the time the products were used, all of the time behavior was good, and half the time germ loading was high, as well as the assumed conditional probability distribution of the Health Metric.

FIG. 4 assumes a new germ introduction, or behavior has grown poor, or people have stopped using the product.

FIG. 5 assumes an ongoing intervention program that may help reduce the level of germs in the facility. In this illustration, the product usage and behavior not only affect the Health Metric directly, but also the germs, and thereby have an additional impact on health.

FIG. 6 assumes a product intervention (increase in use/quality) would drop the baseline from that shown in FIG. 5.

FIG. 7 projects an intervention combining product and behavior that should have the biggest overall impact, driving down germ level and the overall illness rate.

FIG. 8 illustrates the situation of a measurable increase in illness that would indicate that the Germ loading has likely increased, as well as potential decreases in product usage or behavioral compliance.

### DEFINITIONS

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As used herein, the term “resident care location” means a place or location where older people live that is outside the typical home. Examples of resident care locations include, but are not limited to, skilled nursing facilities, hospitals, urgent or emergency care, home professional services, assisted living facilities, or home care; and the like.

As used herein, the term “common areas” means areas generally accessible to multiple people within the resident care location. Such locations in a care complex, for example, are elevators, hallways, break rooms, dining facilities, copy rooms, restrooms, classrooms, lobbies and the like

As used herein, the term “contamination” is intended to mean the presence of contaminants, i.e. viruses, bacteria, mold, fungi, allergens and/or other similar substances, which may cause humans to become ill.

As used herein, the term “cleaner” means a substance that assist in removing dirt and/or debris and contamination from a surface.

As used herein, the term “disinfectant” means an agent or substance that will destroy, inhibit, inactivate or neutralize virtually all of the organisms listed on its label. These organisms are not limited to bacteria but could any contaminants.

As used herein, the term “sanitizer” means a substance that will generally kill most contaminants, particularly but not exclusively bacteria. Sanitizers do not necessarily destroy, inhibit, inactivate or neutralize 100% of the contaminants in order to be effective.

### DETAILED DESCRIPTION

Generally speaking, the present disclosure relates to a comprehensive and systematic approach to promote hygiene and so reduce preventable illnesses in a resident care location. The present disclosure provides a method with a multi-pronged attack on the source of contaminants in a resident care location, which results in a cleaner and healthier resident care location. By methodically monitoring and tracking the cleanliness and health status at resident care locations, the overall transfer of contaminants by a person or people within the facility and/or from one person to another is greatly reduced. It has been discovered people within the resident care location are less likely to become ill from being at the resident care location when adopting the methods of the present disclosure. Compliance with this method has been found to result in reduced rate of infections, reduced hospitalizations and re-hospitalizations, identification of lead indicators of infection, reduced number of antibiotics used, improvement in resident self-perception wellness and improvement in caregiver, staff and family wellness perception. “Caregivers” are a subset of “staff”, but not all staff are caregivers; caregivers have ‘person-to person’ contact with residents; other staff do not have such assignments.

The disclosed method has several steps that are used in conjunction with one another to effectively assist the resident care location and those people within the resident care location to understand and implement tasks that promote improved hygiene. Removing one or more steps of the method of the present disclosure can reduce the effectiveness.

The method includes the following steps which will be discussed in greater detail below:

a. Record collected contaminant data among residents. The contaminant data among residents may be collected by an infection control specialist and inputted into an algorithm, e.g. to computer program application that resides on a computer.

b. Record certain collected data on the condition of the residents as inputs into the algorithm.

c. Provide specific tasks to staff and caregivers for management of the residents. Tasks are generated based on collected data and historical data. Exemplary tasks include staff hand hygiene, resident personal care (e.g. oral care, perineal cleaning), environmental cleaning, ATP sampling.

d. Track completion of the tasks in the computer via input devices.

e. Score compliance to the tasks in the computer and relay scoring to output devices.

f. Generate customized tasks, if necessary, in managing certain residents based on tracking, scoring, and data to reduce the transfer of pathogens within the facility. These customized tasks may be temporary deviations from the tasks generated in step c.

g. Generate feedback (e.g. incentives) for care givers based on tracking, scoring, and data.

A more detailed discussion of each step follows:

Step a: Collect environmental contaminant data for the facility. This step involves the collection of data relating to the initial level of hygiene of the surroundings of each resident using the system. An example of environmental contamination data is information of ATP levels in the facility (discussed in more detail below). This information can include the level of germs, type of germs, the location of germs and the frequency of contact with the germ locations by the resident and/or caregivers. Other factors that may be monitored for data include air quality, the number of steps that must be traversed by the resident in a typical day and the flooring materials or coverings commonly encountered.

Step b: Collect data on the current condition of the residents. This data may include the general and specific state of health of the residents and staff in the facilities of interest and other health-related factors. It can include data relating to current and/or past illnesses, concerns or problems with balance, digestion, sleeping, or the immune system. Information relating to the prescription drug use of the resident may be collected to understand, monitor and contradict if necessary the effects of such drugs on the immune system, on balance, etc. Typical health factors included in this step include:

Temperature - desirably daily
Pulse pressure - desirably daily
Respiration rate - generally done during BP monitoring
Heart rate - desirably daily
Weight change - generally weekly
Change in Cough vs. Normal
Change in Nasal Discharge vs. Normal
Change in Matter in Eyes vs. Normal
Vomiting
Change in Stool Consistency
Declining Mood change
Change in mental status vs. Normal
Skipped/Refused Meal
Hydration Intake less than normal
Change in Mobility vs. Normal
Grip strength
Falls
Infection diagnosis - type of organism or description of sickness, antibiotic
or other treatment use (type and frequency)

Step c: Develop specific tasks and provide them for staff and caregivers for management of the residents. Tasks are determined on data collected in steps a and b as well as any (stored) historical data. The tasks may involve, for example, care giver hand hygiene, resident personal care (e.g. oral care, perineal cleaning), environmental cleaning and ATP sampling of the resident's environment. The tasks involve frequency of cleaning and the specific type of cleaning products to use on certain surfaces based on the germs found and the effectiveness of each product on the germs found.

Step d: Track completion of the tasks. The tasks provided in step c should be completed on a timely basis, using the proper cleaning product(s), procedures and at the prescribed frequency in order to be efficacious.

Step e: Score compliance with the tasks and provide scoring. The adherence to the tasks provided in step c and measured in step d is analyzed and the degree of adherence; the “score” calculated.

Step f: If necessary, generate customized tasks in managing certain residents based on tracking, scoring, and data to reduce the transfer of contaminants within the facility. On subsequent iterations, if it is found that the level of hygiene (step a) and/or the general state of health (step b) has not improved or has declined, temporary additional responsibilities may be generated. This may include more frequent performance of the tasks initially generated in step c, may involve additional or different tasks, or may involve a change in the cleaning products used in performing the tasks.

Step g: Generate feedback, e.g. incentives, for care givers based on tracking, scoring, deviations, and data. When improvements in the level of hygiene or the general state of health result, rewards for compliance may be recommended and distributed to the care givers responsible for carrying out the tasks that led to the improvement. In a typical skilled nursing home, for example, a non-confrontational rivalry between different areas of the facility may be designed and success rewarded with prizes such as cash, time off of work, more convenient employee parking, plaques and name recognition in a prominent place in the facility. Possible results of the feedback may be to improve caregiver staff engagement, improve hygiene behavior compliance, reduce surface contamination and reduce staff turnover.

One of the largest problems in any resident care location is that pathogenic contaminants, especially bacteria and viruses, are generally invisible to the naked eye. A surface or an item can look clean to the human eye, meaning free from dirt or grime, but could be laden with bacteria and/or viruses, which are not visible to the human eye. This presents a problem for the resident care location in that the people using the location are unaware of the potential contaminants on the surface. Many times the surfaces must be touched by people within the resident care location to navigate through the facility or use items at the facility. Examples of surfaces and items that are commonly touched by people within an resident care location include door handles, doors, stairway rails, escalator rails, light switches, elevator buttons, telephones, vending machines, beverage dispensers such as coffee pots, toilets, sinks, faucets, televisions and other similar items.

The method of the present disclosure has a first step which is to collect proxy and actual contaminant data in the resident care location. The initial evaluation can include collecting actual measurements that infer contamination. These levels of contamination may be inferred, for example, through the detection of ATP. ATP is a chemical that is produced by all known living organisms and the amount of ATP present on a surface is widely accepted as a proxy gauge of microbial contamination. Health departments and foodservice inspectors across North America often use ATP readings because they offer quantifiable results that can be weighed from one facility to the next and one day to the next. The higher the ATP reading, the higher the presence of organic residue—and that means a greater likelihood of contamination. Because living things produce ATP, the reading generated can be an indication of the presence of both harmless and potentially harmful substances. Generally, in non-healthcare and non-food processing environments, ATP readings in the 0-100 range are considered to be safe. ATP readings in the 101-300 range are generally considered to contain a degree of contamination that should be disinfected. Readings above 300 are considered to be contaminated and should be disinfected immediately.

ATP readings can be done by commercially available ATP meters, such as those available from HYGIENIA LLC, having offices in Camarillo, Calif. 93012. It is noted that ranges above are specific to the HYGIENIA ATP meters and that an industry calibration standard does not exist, so meters from different manufacturers may have different ranges. It is also noted that the ranges above are merely suggested ranges and they can be adjusted up or down for acceptability depending on the type of facility involved.

The ATP readings may be taken at various locations within the resident care locations on the surfaces mentioned above. Generally, the ATP reading will be taken in the both common areas within the resident care location as well as semi-private and private areas, such as bedrooms, bathrooms, hallways and cafeterias.

In addition to taking ATP reading, further testing could be done to detect microbes. At present, methods to detect microbes are generally more complicated and typically take longer to process; days versus only minutes for ATP testing. As new methods to detect microbes that provide readings in a few minutes are developed, it is anticipated that these methods can be used as well.

Such new methods may include visual inspection or imaging of dirt and contamination on surfaces, measurements of protein, carbohydrates and or reductase associated enzymes. New methods may include methods of determining total bacterial and fungal counts and the measurement of fungal associated enzymes as well as measurement of microbial associated volatile compounds.

The advantage of taking ATP readings and the like is that these readings infer evidence of contamination and allow people at the resident care location to “see” the presence of contaminants. With the inference of the contamination provided by the ATP reading, people within the resident care location are provided with evidence for determining if corrective measures are needed to reduce dangers and unhygienic conditions that may exist in the facility.

Having people within the resident care location observe the testing can provide an advantage in understanding the seriousness and dangers contaminants may cause to their well-being. Information can further be provided by sharing the data collected with people within the resident care location so that they are aware of the areas of concern or hot spots for contamination within the resident care location. Data sharing can be accomplished by any suitable means including verbal interaction with the data collector, visual presentations, e-mails, memos, individual feedback cards, written reports, computer output devices and the like.

Along with the information being shared with those within the resident care location, education of the dangers contaminants may cause to those within the resident care location may also be provided. The information may be provided to all people within the resident care location or to select people within the resident care location. Preferably the information and education is shared with most, if not all people within the resident care location. By providing this information and education, it is believed that the people within the resident care location will become sensitized to the overall hygiene of the resident care location and the dangers contaminants may cause to those within the resident care location.

In addition to determining the presence of bacteria, viruses or illnesses, the data collection on the current condition of the residents could also ascertain observations and tracking of the behaviors of the people within the resident care location. These observations could include behaviors before eating, behaviors with respect to hand washing routines after using the restroom, and behaviors with respect to using shared items within the resident care location, such as coffee stations, vending machines and the like. The observations may assist in identifying “hot spots” of higher contamination that may need to be addressed.

The initial data may be collected within a few hours, over a period of day or over a period of week. Data may be collected before cleaning crews clean the resident care location and/or after the cleaning crews clean the resident care location. Data may be collected at different times during the day, for example, in the morning, at noon or in the evening. The data is generally collected over period of a few days with the surfaces of the more commonly used items being collected at multiple times. Generally, the average of multiple readings may be used for comparison. However, generally the highest readings, which may possess the highest risk to the people within the resident care location, may also be reported. To get a true picture of the level of contamination, the initial data will generally be collected over a short period of time, generally of about a few hours to a couple of days to a full week. The initial data will serve as a baseline to which future testing data, desirably carried out in the same manner, will be compared. In addition, the initial data will help identify specific needs and areas of focus in the resident care location.

Once the initial data is collected for use in steps a and b above, the next step in the method is evaluation of the initial data and the development of specific tasks for the care givers and the resident. The initial data is evaluated to identify specific needs and areas of focus within the resident care location. Based on the data collected, specific tasks using particular types of products and the method of use of those products will be recommended. In addition, the collected data may be compiled in a database for retrieval at a later date for comparison purposes.

Compliance to tasks is a necessary part of the method. One way of monitoring compliance with the tasks may be accomplished by performing regression analysis of infection and proxy data accounting for the main effects (pathogen activity, product efficacy, and behavior) and interactions (pathogen*product, pathogen*behavior, product*behavior, and pathogen*product*behavior).

After regression analysis:

a. If no terms are statistically significant at a specified level of confidence, then there is no evidence of a correlation between pathogen levels, product efficacy, and behavior.
i. This may indicate that the system is unaffected or resistant to the interventions (e.g. no incremental benefit from product, behavior circumvents intervention, or already at the baseline infection rate) or that the causal behaviors or intermediate products or fomites were not measured.
ii. If there is a confirmed benefit found in other research (e.g. bench studies of product efficacy, similar studies in other environments) this may indicate that noise terms are dominating or the benefit requires a particular interaction (e.g. product efficacy masked by detrimental behavior).

b. If significant terms are found, this identifies the pathogen, product, and behavior combination that should be addressed.
i. For example, a product main effect shows that a particular product generally increases or decreases the risk of infection, regardless of behavior. A product-behavior interaction indicates that a product may be helpful only in the context of certain behaviors.

c. Follow-up action
i. If no terms are significant, and the infection rate is unacceptably high, additional measurements of behaviors or intermediate surfaces should be tracked at the next round of auditing.
ii. Any statistically significant terms highlight areas for new attention.

In addition, other ways of determining whether a significant main effect or interaction is occurring in a particular system or environment may be used. For example, in more well-defined environments and contexts, one may use discrete event simulation, survival analysis, or similar methods to model behaviors or the system as a whole over a period of time. More realistic models characterizing contaminant survival or a particular mode of contaminant inactivation may be appropriate (e.g. including humidity, temperature, organic sources).

When using time-resolved data (e.g. via RFID, continuous, intermittent, or event-driven data recording), then additional sequence-based interactions could be tracked and used for inputted data. This may include, for example, washing before and/or after using the restroom or eating. The sequence of doing certain events in relation to other events is important. Moreover, these interactions might be discovered through various data-discovery and/or machine learning and pattern matching approaches (e.g. neural networks, support vector machines).

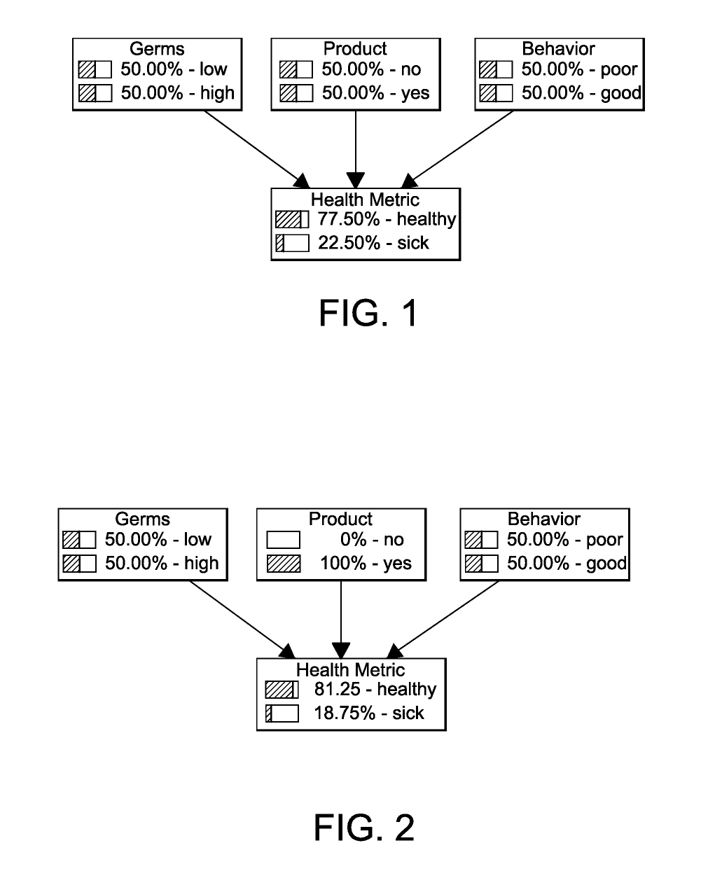

The algorithm for the method can be based on one or more computational models. For example, a model could be in the form of a Probabilistic Graphical Model (PGM), Bayesian or Markov network. A simple form could be discrete high/low levels for Germs (e.g. high/low loading), Products (used/not used), Behavior (e.g. good/poor behavior), and the Health Metric (e.g. healthy/sick). From the study, the amount of Germs (or surrogate values), usage of the Product, and Behavior would be tracked along with the Health Metric. Each combination would give rise to a probability distribution of getting sick. Such a PGM could look like FIG. 1, using hypothetical numbers for the probability of infection given a certain (Germ, Product, Behavior) combination. In FIG. 1, for demonstration, we assume ½ the time the products were used, ½ the time behavior was good, and ½ the time germ loading was high, as well as the assumed conditional probability distribution of the Health Metric. In this example we would expect 22.5% of the people to be sick.

Exclusive use of a product with improved efficacy would shift the Product prior to “yes”, thus affecting the Health Metric leading to a decreased health risk. In our example only 18.75% of people would be expected to be ill, as shown in FIG. 2. FIG. 2

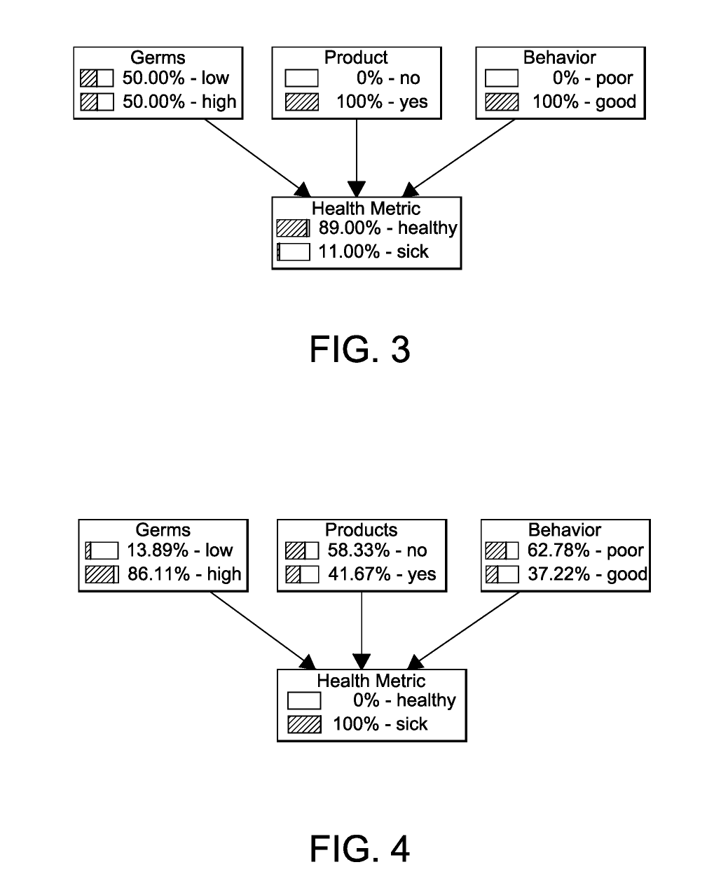

Tasks of the method can include more than care giving, cleaning, facility maintenance, and reporting (recording). They may include interventions. A non-limiting example of an invention is an educational program about and of products that are meant to improve Product and Behavior. Such interventions are intended to have additional/synergistic effects. Through an intervention we could record and observe that people were using the product and behavior had changed, then the illness rate would drop to 11% as shown in FIG. 3.

Alternatively, if between data collections, e.g. an audit, if the Health Metric went dramatically up (e.g. large increase in infections), then that would change the modeling relationships about the Germ, Product, or Behavior. In this example, a rapid increase in infections would be probably due to a new germ introduction (50%-86% probability of a high level of loading), or behavior has grown poor, or people have stopped using the product. This relationship is shown in FIG. 4.

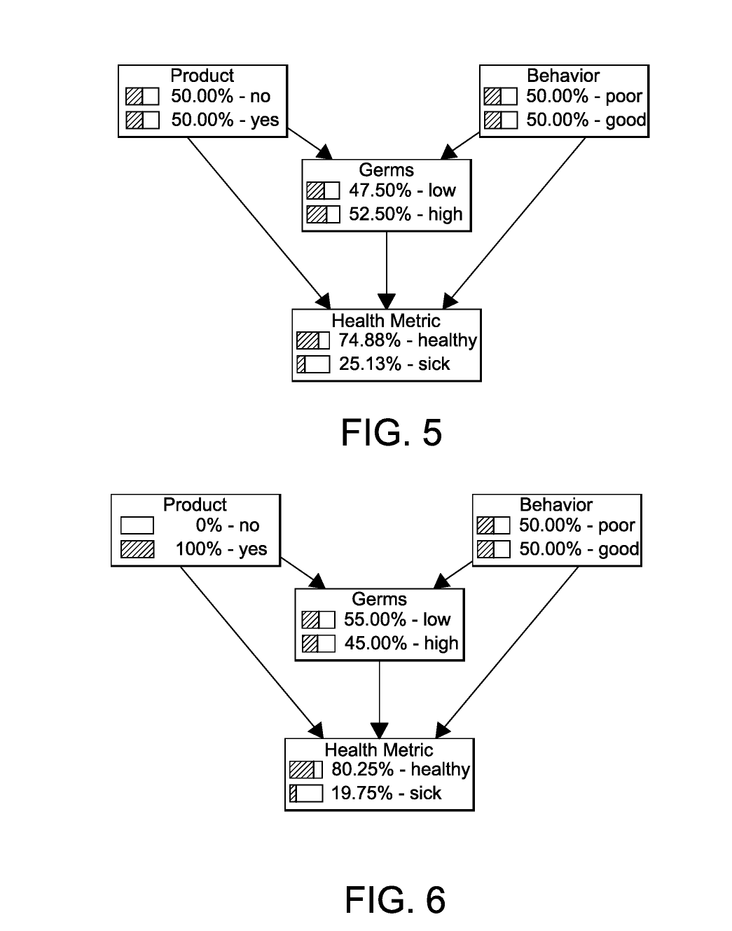

Alternatively, a PGM could involve an ongoing intervention program that may help reduce the level of germs in the facility. Such a PGM could look like the FIG. 5, where the product usage and behavior not only affect the Health Metric directly, but also the germs, and thereby have an additional impact on health. In this case, the baseline illness rate is 25% (FIG. 5) and a product intervention would drop the baseline from 25% to ˜20% (FIG. 6).

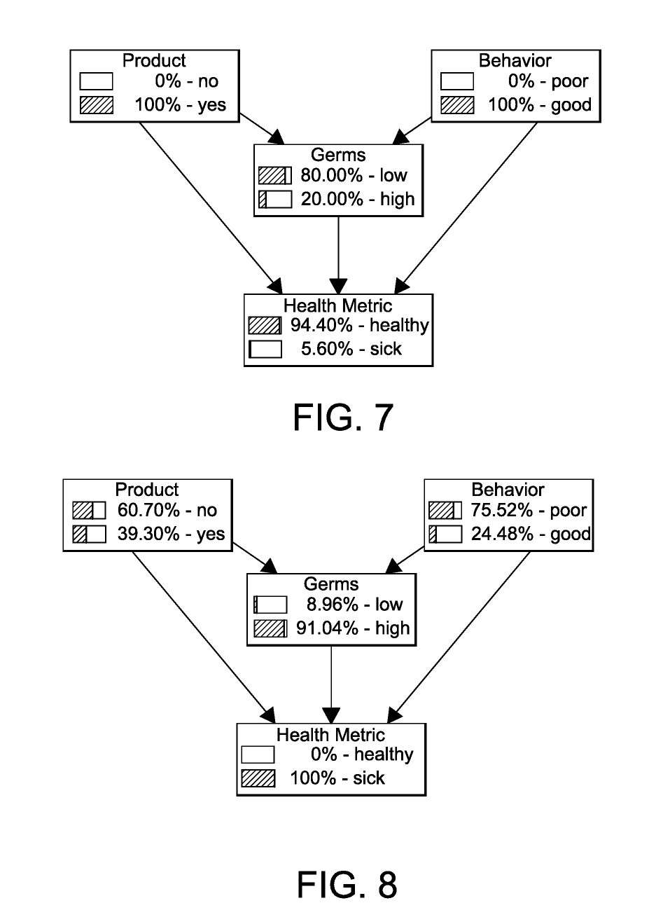

An intervention combining product and behavior would have the biggest overall impact, driving down germ level, and an overall illness rate of fewer than 6% in our example (FIG. 7).

As before, if between audits, there was a measurable increase in illness, this facility-specific PGM would indicate that the Germ loading has likely increased, as well as potential decreases in product usage or behavioral compliance. While this is intuitive, a PGM based on data from a particular facility would give quantitative estimates for the shifts that have occurred, as shown in FIG. 8.

The tasks can include prompts to use certain specific products in the resident care location that can help reduce transferring contaminates from one person to another, from one surface to another, from a person to a surface or from a surface to a person. The products will generally include both hand sanitizers, surface disinfectants and surface sanitizers to assist in diminishing the transfer of contaminants from and to the hands of a user. The products can include facial tissue, soaps, paper toweling, door handle sanitizers, air filters, air disinfecting sprays, wall brackets to hold products, centralized hand/surface hygiene stations and other similar products. The tasks may also provide suggestions for placement of these products which will help facilitate the usage of the products and have the suggested products in a location such that the products are readily available for usage in the identified hot spots.

The tasks may also include providing education/training to at least one person at the resident care location. The size of the resident care location will determine how the training will be implemented and how many people will be trained. Education/training can be provided to all people at the resident care location or education could be provided to a select group of individuals that will teach others at the resident care location to use the products. Education or training may include on the proper use of the products suggested for use in the plan of action, where and when to use the products, how often to used and how the proper use of the products will promote hygiene in the resident care location, by helping reduce contamination. In addition, education may be provided by providing illness outbreak alerts regarding an outbreak or potential outbreak of an illness in the region where the resident care location is located, e.g.; influenza outbreaks. Education may be provided through product literature, classroom training, hands on training, web-based training and through outbreak alerts.

The hand sanitizers can be in the form of a gel, foam or a liquid. Generally gels and foams will be dispensed from containers such as bottles that are typically placed on a horizontal surface. Alternatively, the hand sanitizer may be dispensed from a dispenser. Dispensers may be in the form of wall mounted dispensers or dispensers with are free standing floor units or mounted on a free-standing pedestal adapted to hold the dispenser. Hands-free dispensers are very effective in dispensing the hand sanitizer since the user will not have to touch the dispenser. Hand sanitizer will generally be provided in locations where hand sanitizer will be typically needed. Alternatively, hand sanitizers may be provided in the form of a saturated wipe. For example, the hand sanitizer can be located at restroom exits, or outside restrooms, in or near rooms where food may be handled, in or near cafeterias or other similar food dispensing areas and other common areas typically found in resident care locations.

Surface cleaners, disinfectants and/or sanitizers may be in the form of a saturated wipe, a spray, foam, or a liquid. Saturated wipes may be provided in a dispensing canisters, wall units, free standing floor units, or from a free standing pedestal adapted to hold a canister or dispenser of saturated wipes. Generally, the canister or dispenser will be adapted to dispense a single wipe at a time. Alternatively, the surface sanitizer may be in the form of a spray, liquid, or foam. By spray, it is intended that the surface sanitizer is dispensed in a mist of fine fluid droplets. In contrast, liquid is intended to mean a fluid that is not a spray or foam. If the surface sanitizer is provided as a liquid, foam or spray, provide nearby will be a wiper of some sorts, such as a paper towel, so that the user can effectively spread the surface sanitizer on the surface being sanitized. Desirably, but not required, the surface sanitizer should have a long lasting effect such that once the surface is sanitized, the surface sanitizer continues to actively sanitizer the surface for a period of time. An exemplary period of time would be for at least one hour. Longer periods of time, for example 2 hours, 4 hours, 8 hours, or 24 hours, or any period of time in between these exemplary periods of time would be considered especially advantageous. Generally, the surface sanitizer will be provided in places where people within the resident care location typically touch or interact with surfaces.

The products may also contain products with uses in specific locations. Examples of such products include products used in restrooms or break rooms including hand soaps and disposable paper toweling. Providing hand soap to persons within the resident care location provides a way for a user to remove dirt and other contaminants from a user's hand. It is noted that hand sanitizers sanitize the hands of the users of the hand sanitizer, but hand sanitizers are generally not useful in removing dirt and other particulate types of contaminants from a user's hands. In addition, paper toweling has been advantageously used to dry and further clean hands of a user. A University of Westminster study, “A Comparative Study of Three Different Hand Drying Methods: Paper Towel, Warm Air Dryers and Jet Air Dryers” by Keith Redway and Shameem Fawdar, November 2008, showed that hand towel are more effective in removing bacteria from a user's hand than forced air dryers.

It is a further advantage to have both the hand soap and paper towel dispensed from hands-free dispensers so that the user does not have to touch surfaces in a restroom. Providing additional features in the restroom such as hands free toilet and water faucet values may also be advantageous.

Perineal cleaning is an important factor in reducing infection. Perineal cleaning products include skin cleansers and washes to delicately clean the perineal area; soft, disposable, hygienic towels for use instead of laundered wash cloths; pre-moistened, soft, moisturizing wipes used as a final finishing, cleaning step; used prior to applying ointment or balms. In addition, gloves, particularly extended cuff gloves offering better hygiene protection for the caregiver when conducting peri care are desirable.

A further source of contamination is through the air. Air quality analysis may be used to determine the quality of the air in the facility. It is contemplated that the tasks may also include products such as air filters which are used to filter the air within the resident care location. Any suitable filter material may be used, however, those filter materials that are effective in trapping bacterial are more desirable. In addition, disinfecting sprays may be used to assist in reducing airborne contaminants.

Once the tasks have been accomplished, they should be kept track of (step d) so that compliance score (step e) may be calculated. Tracking also encourages the resident or caregiver to actually perform the assigned task. In addition to tracking the performance of the tasks, tracking may include product consumption rates, and infection symptoms and changes in resident condition (i.e. health status).

Another aspect of the method (step g) is to provide residents and care givers' motivational means and incentives that will effectively promote compliance with the tasks generated. In this way, the full benefits of the disclosed method can be realized. Examples of suitable motivational means include, for example, e-mails, videos, surveys, contest, prizes for compliance and/or employee or user engagement and combination thereof.

Suitable e-mails and videos may include information regarding how to use products, the benefits of the products, results from the test protocol, improvements obtained in hygiene at the resident care location, percentage of the employees or users currently complying with assigned tasks, regional illness outbreak information or a combination thereof. The e-mail or video may come from a designated person within the resident care location who is in charge of implementing the tasks. As a result, compliance with the tasks will generally be improved in those areas with the poorest results as a sense of personal pride may come into play. Likewise in the areas of having the best results will continue to strive to be the leader, thereby maintaining compliance with the tasks in those areas as well.

One very effective way to promote employee or user engagement is to have contest between different areas within the resident care location. Winners of the contest could be provided with prizes or just recognition as being the area with the best hygiene. With prizes being awarded, there is additional incentive to comply with the tasks.

Once tasks have been generated, communicated and implemented, the method should be repeated to ensure it is having the desired effect. The resident care location may be reevaluated for contaminants as was performed initially and the resident health information updated. Once collected, the secondary data is compared to the initial data to determine if the tasks are effective in reducing contamination at the resident care location. Tasks are again assigned and tracked for completion and the process scored. As result of the data, tracking and scoring, additional tasks may again be developed (step c) to obtain an overall improvement in the level of contamination.

If areas within the resident care location have not improved with respect to contamination, the tasks may need to be reevaluated for effectiveness and actual compliance. If the secondary data does not indicate an improvement in contamination, it may suggest that the tasks are not being followed by the resident care location and further assistance or further education may need to be provided.

In addition to collecting the secondary data, surveys or usage rates of the specific products suggested in the tasks may also be evaluated. Low product usage and/or little to no improvement in the level of contamination may indicate low user participation in the tasks. In this case, further education or other motivational means might need to be provided to people within the resident care location to improve the overall hygiene in the resident care location. It may be necessary to change the motivational means currently being used in the resident care location to others described above.

As a further aspect of the present disclosure, additional sets of data may be collected on a regular basis and compared to the prior set of data or all of the previously collected and stored data. Continuing monitoring and evaluation using defined test protocols is an effective way to prevent the resident care location from regressing in its hygiene. Future testing should be conducted on a regular basis and may be as extensive as the initial testing, reduced to a statistically significant sampling or limited to those spots indicated by either the initial testing or the secondary data collection as being hot spots.

It is desired to drive behavior change among those at the resident care location in a manner so as to improve hygiene in the resident care location and to potentially reduce the spread of illness within the resident care location. By providing feedback and incentives and engaging the employees or users of the resident care location, behavior change is driven in a positive manner. Effective motivation of the employees or users at the resident care location will tend to close the gap between those who perform the tasks and those that do not. One example of an effective motivational means is to provide positive reinforcement to those who have performed their tasks therein providing an incentive for those who have not performed their tasks to do so.

As was discussed above, the data collected for each location may be stored in a database. Repeating the collection process for several different locations may result in a database that can be quickly accessed and information retrieved for the purposes of recommending tasks. All of the information including described above may be stored. In addition, the secondary data may also be stored. The database may also track the performance of tasks including any employee or user engagement means. The purpose of storing data is to later track similarly situated resident care locations that have similar number of employees or users and similar facilities. By using a database of the data collected from initial testing and secondary testing, the database can be used in a further process of the present disclosure.

In yet another embodiment, an abbreviated series of steps may be used. These include:

a. Initial identify the product/protocol “adherence gaps”. This involves auditing (studying) the facility's infection control products in use and the protocols (cleaning procedures) the facility is using and identifying “gaps” or areas of potential improvement, prior to taking any actions or making any changes in the facility.

b. providing tasks to the staff that should reduce the incidence of illness among facility residents if properly carried out. This can include suggestions for improvements in product selection (performance) as well as protocol adherence, e.g. compliance with cleaning procedures.

c. tracking consumption of cleaning products by, for example, keeping track of inventory and, optionally, tracking infection data and/or microbe population information (e.g. ATP levels),

d. measuring compliance to the tasks that were provided above and providing scoring to the staff.

The embodiment may also include “benchmarking”, i.e., comparing one facility to another to develop and share best practices. Benchmarking may involve comparing illness rates among residents of similar facilities to develop insight into which cleaning products and procedures may be more successful in lowering the illness rates. It is believed that this process will reinforce the message to the staff that their compliance to the tasks is very important in reducing illness rates among the residents of their facility.

It is important in working with the staff that they be engaged and trained in the tasks that they are asked to perform. As part of the step of providing tasks to the staff, training should be carried out regarding the proper use of cleaning products. Engagement surveys by third party consultants may be used to gauge and encourage engagement of the staff. Rewards may be provided for exceptional engagement and reaching task goals.

In still another embodiment, a method for controlling ATP levels within a care facility having residents, staff, and caregivers is provided. This method can include the steps of:

a. collecting ATP data within the facility,

b. collecting data on the health status of the residents,

c. inputting the collected data into a computational algorithm to develop tasks for the staff and caregivers

d. providing the tasks to the staff and caregivers,

e. tracking completion of the tasks (or protocol adherence),

f. measuring compliance to the tasks and providing scoring to the staff and caregivers.

This could also include the step of generating feedback for caregivers based on tracking, scoring, deviations, and data.

Although the present disclosure has been described with reference to various embodiments, those skilled in the art will recognize that changes may be made in form and detail without departing from the spirit and scope of the disclosure. As such, it is intended that the foregoing detailed description be regarded as illustrative rather than limiting and that it is the appended claims, including all equivalents thereof, which are intended to define the scope of the disclosure.

What is claimed is:

1. A method for promoting hygiene and reducing preventable illnesses in an resident care location having residents and care givers, comprising the steps of:
a. collecting environmental contaminant data among residents,
b. collecting data on the condition of the residents,
c. inputting data into a computational algorithm to develop tasks for care givers for management of the residents based on data,
d. providing the tasks to the care givers,
e. tracking completion of the tasks,
f. scoring compliance to the tasks and providing scoring to the caregivers,
g. generating customized tasks in managing certain residents based on tracking, scoring, and data to reduce the transfer of pathogens within the facility, and;
h. generating feedback for care givers based on tracking, scoring, deviations, and data.

2. The method according to claim 1, further comprising repeating the method to determine improvement in resident health.

3. The method according to claim 1, further comprising repeating the method at several resident care locations and compiling the collected data in a database.

4. The method according to claim 1, wherein the incentives comprise e-mails, videos, surveys, contest, prizes for compliance and/or engagement and combination thereof.

5. The method according to claim 1, wherein said tracking comprises completing surveys on usage of specific products used to execute the tasks.

6. The method according to claim 5, wherein the specific products comprise hand sanitizer, surface cleaners, surface disinfectants, surface sanitizers, and facial tissues.

7. A method for promoting hygiene and reducing preventable illnesses in a care facility comprising the steps of:
a. initial identification of product/protocol adherence gaps,
b. providing tasks to the staff,
c. tracking consumption of cleaning product inventory, and/or infection data and/or microbe population information,
d. scoring compliance to the tasks and providing scoring to the staff.

8. The method of claim 7 further comprising the step of benchmarking the facility with other similar facilities.

9. A method for controlling ATP levels within a care facility having residents, staff, and caregivers comprising the steps of:
a. collecting ATP data within the facility,
b. collecting health status data of the residents,
c. inputting the collected ATP and health status data into a computational algorithm to develop tasks for the staff and caregivers,
d. providing the tasks to the staff and caregivers,
e. tracking completion of the tasks,
f. measuring compliance to the tasks and providing scoring to the staff and caregivers.

10. The method of claim 9 further comprising the step of generating feedback for caregivers based on tracking, scoring, deviations, and data.
